(19) United States
(12) Patent Application Publication
(10) Pub. No.: US 2022/0187626 A1
(43) Pub. Date: Jun. 16, 2022

(54) INTELLIGENT VIRTUAL DISPLAY DEVICE

(71) Applicant: MATAVIEW PHOTOLOGY CO., LTD., Taichung City (TW)

(72) Inventors: Mang OU-YANG, Hsinchu City (TW); Sheng Chun HUNG, Dongshan Township (TW); Yen Jui CHEN, Hsinchu City (TW); Yung-Jhe YAN, Taipei City (TW); Jin-Chern CHIOU, Hsinchu City (TW); Cheng-Wei TSAI, Taichung City (TW)

(73) Assignee: National Yang Ming Chiao Tung University, Hsinchu City (TW)

(21) Appl. No.: 17/188,385

(22) Filed: Mar. 1, 2021

(30) Foreign Application Priority Data
Dec. 14, 2020 (TW) 109144113

(51) Int. Cl. G02C 7/08; G02C 7/04; G02C 7/10; G02C 11/00; G02B 27/01; H02J 50/80

(52) U.S. Cl. CPC G02C 7/083; G02C 7/04; H02J 50/80; G02C 11/10; G02B 27/0101; G02C 7/101

(57) ABSTRACT

The present invention provides an intelligent virtual display device including a contact lens. The contact lens has a central area thereon, a micro display disposed outside the central area, a wearable reflector disposed corresponding to the micro display and configured to receive and to reflect images of the micro display, and a controller. The controller is connected with the micro display and configured to send the control signals to the micro display so as to generate the images. The contact lens is designed for being worn on a user's eyeball. When the eyeball rotates, the micro display changes its projection direction simultaneously to match the user's visual angle.

This application claims priority of Application No. 109144113 filed in Taiwan on 14 Dec. 2020 under 35 U.S.C. § 119; the entire contents of all of which are hereby incorporated by reference.

### BACKGROUND OF THE INVENTION

### Field of the Invention

The present invention relates to a VR (Virtual Reality) data processing technology, particularly to an intelligent virtual display device.

### Description of the Prior Art

With rapid development of science and technology, various image display technologies are also fast evolving. At present, the related manufacturers are enthusiastic to develop VR head-mounted virtual display devices and AR (Augmented Reality) head-mounted virtual display devices. Thus, the VR and AR technologies have been extensively applied to the fields of entertainment, flight training, medicine, etc.

However, the additional optical components, which are used to enhance light projection efficiency, make the head-mounted virtual display devices become very bulky and significantly impair the convenience of users.

At present, there have been simplified AR glasses (such as the Google glass) whose appearances are similar to ordinary glasses. The lateral side of the frame of a simplified AR glass is normally equipped with a touch panel, which is used to control the pictures presented by the LED (Light Emitting Diode) display device disposed on the frame. The LED display device provides images and projects the images to the reflector on the frame, whereby the user can view the images projected by the LED display device.

No matter whether the head-mounted virtual display device is a bulky VR one or a simplified AR one, it needs a pupil tracking device to track the position of the pupil of the user. Thus can be adjusted the projection angle of the display device or the optical component. The pupil tracking device not only raises the cost but also increases the weight. Further, the data detected by the pupil tracking device may have errors. Therefore, using the pupil tracking device to adjust the projection angle is not the optimized technology for users.

Accordingly, the present invention proposes an intelligent virtual display device to overcome the abovementioned problems

### SUMMARY OF THE INVENTION

The primary objective of the present invention is to provide an intelligent virtual display device, whose micro display is worn on the eyeball of the user, whereby while the eyeball rotates, the micro display can synchronously change the projection direction to meet the viewing angle of the user.

Another objective of the present invention is to provide an intelligent virtual display device, which can instantly present information in front of the eyes of the user, whereby the present invention features simultaneity and privacy.

In order to achieve the abovementioned objectives, the present invention provides an intelligent virtual display device, which comprises a contact lens and a wearable reflector. The contact lens has a central area and a micro display in the interior of the contact lens and outside the central area. The wearable reflector is disposed corresponding to the micro display, receiving and reflecting the images of the micro display. The wearable reflector includes a controller. The controller is wirelessly connected with the micro display and emits control signals to control the micro display to generate images.

In one embodiment, the wearable reflector includes a frame and at least one reflecting mirror. The frame further includes a pair of rims and at least two temples. The pair of temples are respectively disposed at two sides of the pair of rims. The controller is disposed on at least one temple. The reflecting mirror is disposed on the rim of the frame and corresponding to the micro display, receiving and reflecting the images of the micro display.

In one embodiment, the reflecting mirror is a curved-surface reflecting mirror.

In one embodiment, the micro display is a micro LED display or a mini LED display.

In one embodiment, the controller further includes a wireless charging device. The wireless charging device is wirelessly connected with the micro display, providing wireless charging signals to the micro display and thus supplying electric energy to the micro display for operation.

In one embodiment, the micro display includes a substrate, a receiver; a rectifier, an energy storage element, a driver circuit, and a LED array. The receiver, the rectifier, the energy storage element, the driver circuit, and the LED array are disposed on the substrate. The receiver is wirelessly connected with the micro display and the wireless charging device, and configured to receive the wireless charging signals from the wireless charging device and the control signals from the controller. The rectifier is connected with the receiver, and configured to receive and rectifying the wireless charging signal. The energy storage element is connected with the rectifier, and configured to receive the rectified wireless charging signal and converting the rectified wireless charging signal into electric energy for storage. The driver circuit is connected with the energy storage element and the receiver, and configured to receive electric energy and control signals. The LED array is connected with the driver circuit. The driver circuit provides electric energy for the LED array and controls the LED array to operate according to the control signals.

Below, embodiments are described in detail to make easily understood the objectives, technical contents, characteristics and accomplishments of the present invention.

### BRIEF DESCRIPTION OF THE DRAWINGS

FIG. 1 schematically shows that the device of the present invention is worn by a user.

FIG. 2 schematically shows a side view of the present invention.

FIG. 3 schematically shows a contact lens of the present invention.

FIG. 4 is a block diagram showing the system a micro display of the present invention.

FIG. 5 schematically shows operation of the present invention.

### DETAILED DESCRIPTION OF THE INVENTION

The intelligent virtual display device of the present invention can immediately present information before the eyes of the user and features simultaneity and privacy. Further, the present invention enables the micro display to be worn on the eyeball of the user. While the eyeball rotates, the micro display can synchronously change the projection direction to match the viewing angle of the user.

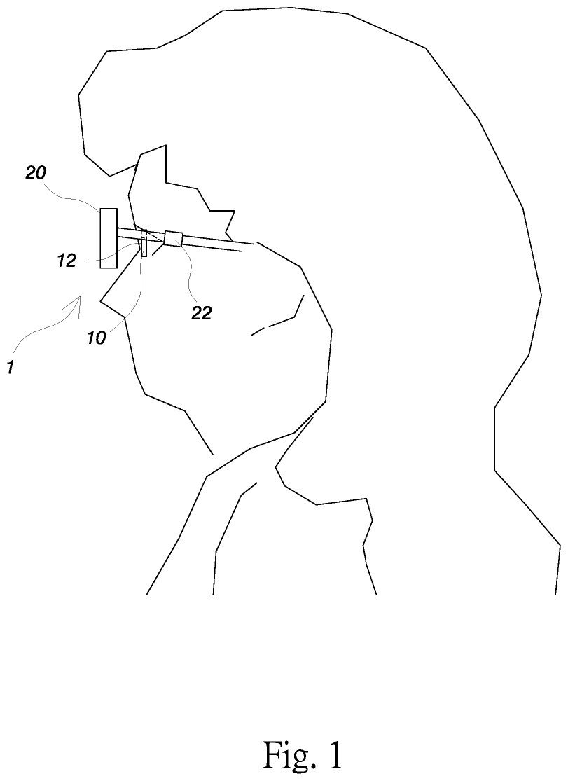

The structure of the intelligent virtual display device of the present invention is described below to demonstrate how the technology of the present invention achieves the abovementioned functions. Refer to FIG. 1. The intelligent virtual display device 1 of the present invention comprises a contact lens 10 and a wearable reflector 20. In one embodiment, the contact lens 10 is worn on the eyeball of the user and includes a micro display 12, which can project images. The appearance of the wearable reflector 20 is similar to a pair of glasses, and the user may wear the wearable reflector 20 on the face. The wearable reflector 20 is disposed corresponding to the micro display 12, receiving and reflecting the images of the micro display 12. The reflected images are imaged on the eyeball of the user.

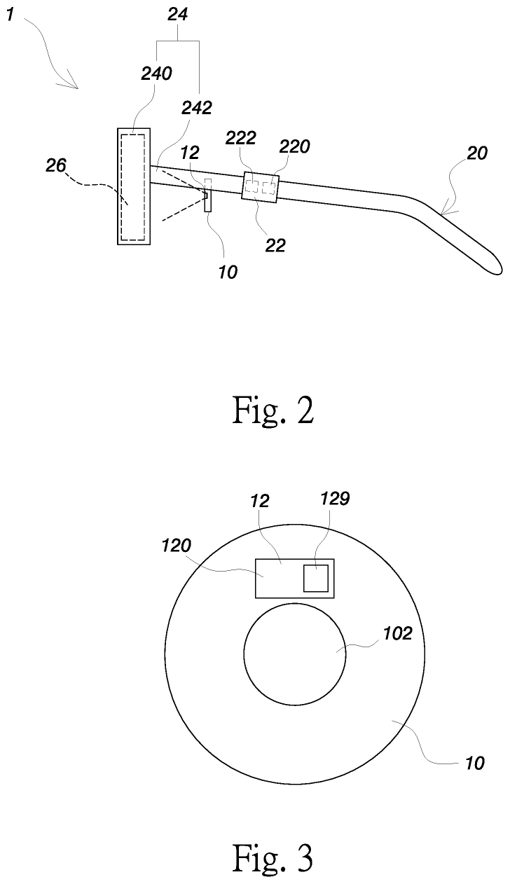

Refer to FIG. 2 for the detailed structure of the wearable reflector 20. In one embodiment, the wearable reflector 20 includes a controller 22, a frame 24, and at least one reflecting mirror 26. Both the controller 22 and the reflecting mirror 26 are installed in the frame 24. The frame 24 further includes a pair of rims 240 and at least two temples 242. The two temples 242 are respectively arranged in two sides of the rims 240. The controller 22 is disposed on at least one of the temples 242. The controller 22 is wirelessly connected with the micro display 12. The controller 22 further includes a signal transmission device 222 and a wireless charging device 220. The signal transmission device 222 is wirelessly connected with the micro display 12. The controller 22 generates control signals; the signal transmission device 222 transmits the control signals to the micro display 12 to control the micro display 12 to generate images. The wireless charging device 220 of the controller 22 is wirelessly connected with the micro display 12, providing wireless charging signals to the micro display 12 to enable the operations of the micro display 12. The reflecting mirror 26 is installed in the rims 240 of the frame 24 and corresponding to the micro display 12 for receiving and reflecting the images of the micro display 12. In one embodiment, the reflecting mirror 26 is a curved-surface reflecting mirror. In some embodiments, the reflecting mirror 26 is a mirror able to reflect light, such as a light splitter, an anti-blue ray lens, or a plastic lens. It should be explained: in the present invention, the reflecting mirror 26 is not necessarily a total-reflection mirror but may be a transflective lens, which the user may wear in daily living. Besides, the reflecting mirror 26 may be fabricated to have a required diopter to function as a pair of ordinary glasses and provide vision correction. However, the reflecting mirror 26 may be a piece of non-prescription glass.

Next is described the structure of the contact lens 10. Refer to FIG. 3. The contact lens 10 has a central area 102 thereon. In one embodiment, while the user wears the contact lens 10, the central area 102 is exactly aligned to the pupil of the user. The micro display 12 is embedded inside the contact lens 10. However, the micro display 12 is disposed outside the central area 102 lest the micro display 12 cover the pupil and impair the vision. Further, the central area 102 may be fabricated to have a required diopter to provide a vision-correction function of an ordinary contact lens. Besides, the central area 102 may be a non-prescription design.

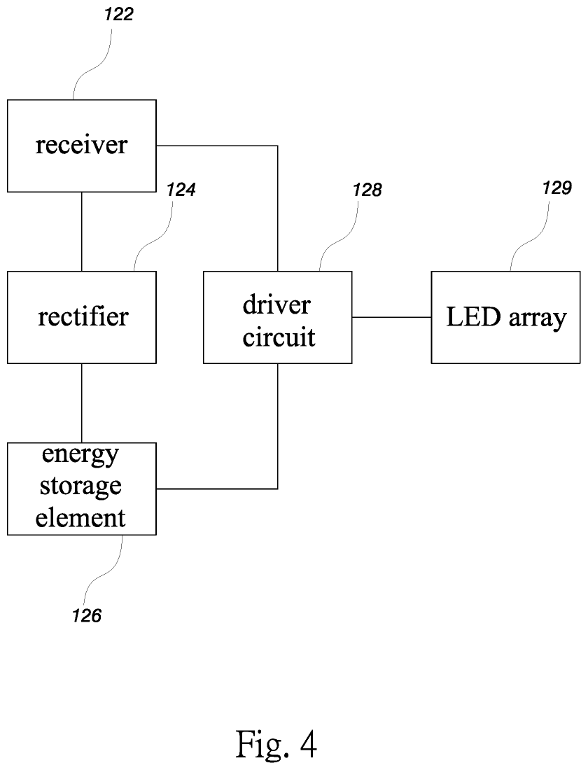

Next, the structure of the micro display 12 is described in detail below. Refer to FIG. 3 and FIG. 4. The micro display 12 may be a micro LED display or a mini LED display. In one embodiment, the micro display 12 includes a substrate 120, a receiver 122, a rectifier 124, an energy storage element 126, a driver circuit 128 and a LED array 129. The receiver 122, the rectifier 124, the energy storage element 126, the driver circuit 128 and the LED array 129 are all disposed on the substrate 120. The receiver 122 is wirelessly connected with the wireless charging device 220 and the signal transmission device 222, and configured to receive the wireless charging signals of the wireless charging device 220 and the control signals transmitted by the wireless transmission device 222. The rectifier 124 is connected with the receiver 122, and configured to receive and rectifying the wireless charging signals input by the receiver 122. The energy storage element 126 may be an energy storage capacitor. The energy storage element 126 is connected with the rectifier 124, and configured to receive the rectified wireless charging signals, converting the rectified wireless charging signals into electric energy, and storing the electric energy. The driver circuit 128 is connected with the energy storage element 126 and the receiver 122, and configured to receive the electric energy and the control signals. The driver circuit 128 controls the LED array 129, which is connected with the driver circuit 128, to emit light according the control signals. In one embodiment, the LED array 129 may be a micro LED array or a mini LED array. The LED array 129 may be disposed on the substrate 120. However, the present invention does not limit that the LED array 129 must be disposed on the substrate 120. The LED array 129 may be independently disposed outside the substrate 120 as long as the LED array 120 is connected with the driver circuit 128.

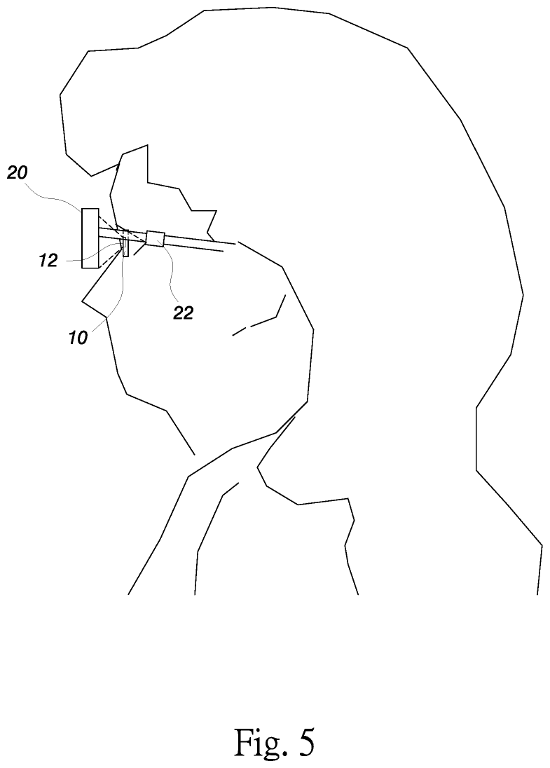

Next, the operation of the intelligent virtual display device 1 is described in detail below. Refer to FIG. 2, FIG. 3 and FIG. 5. Firstly, the user wears the contact lens 10 on the eyeball and wears the wearable reflector 20 on the face corresponding to the position of the micro display 12. The distance between the reflecting mirror 26 and the micro display 12 is maintained equal to the curvature radius of the curved-surface reflecting mirror, whereby the reflected images can be focused on the retina of the human eye to let the user see images clearly. After the wearing activities are completed, the user manually operates the controller 22 on the temple 242 of the wearable reflector 20 to make the controller 22 emit the control signals and the wireless charging signals to the micro display 12 inside the contact lens 10. According to the control signals and the wireless charging signals, the micro display 12 generates images. Next, the micro display 12 projects the images to the reflecting mirror 26 of the wearable reflector 20. Thus, the reflecting mirror 26 presents complete images. Then, the user can see the images presented by the micro display 12 via the reflecting mirror 26.

The present invention is characterized in that the micro display 12 is installed on the eyeball of the user. While the eyeball rotates, the projection angle of the micro display 12 also moves to the viewing angle of the user correspondingly. Therefore, the present invention can omit the pupil tracking device, lower the cost, and decrease the thickness of the device. Moreover, the present invention can guarantee that the projected images match the viewing angle of the user.

In conclusion, the present invention can instantly present information in front of the eyes of the user, featuring simultaneity and privacy. Further, the micro display is worn on the eyeball of the user. Therefore, while the eyeball rotates, the micro display can synchronously change the projection direction to match the viewing angle of the user.

The embodiments described above are only to exemplify the present invention but not to limit the scope of the present invention. Any equivalent modification or variation according to the spirit or characteristics of the present invention is to be also included by the scope of the present invention.

What is claimed is:

1. An intelligent virtual display device, comprising
a contact lens, including a central area thereon and a micro display disposed outside said central area; and
a wearable reflector, disposed corresponding to said micro display, receiving and reflecting images of said micro display, and including a controller, wherein said controller is connected with said micro display and sends out control signals to said micro display to control said micro display to generate said images.

2. The intelligent virtual display device according to claim 1, wherein said wearable reflector includes
a frame, further including a pair of rims and at least two temples, wherein said at least two temples are respectively disposed at two sides of said pair of rims, and said controller is disposed on at least one of said temples; and
at least one reflecting mirror, disposed on said pair of rims of said frame and disposed corresponding to said micro display, and receiving and reflecting said images of said micro display.

3. The intelligent virtual display device according to claim 2, wherein said reflecting mirror is a curved-surface reflecting mirror.

4. The intelligent virtual display device according to claim 2, wherein said reflecting mirror is a light splitter, an anti-blue ray lens, or a plastic lens.

5. The intelligent virtual display device according to claim 1, wherein said micro display is a micro light emitting diode (micro LED) display or a mini light emitting diode (mini LED) display.

6. The intelligent virtual display device according to claim 1, wherein said controller further includes a wireless charging device, which is wirelessly connected with said micro display to provide wireless charging signals to said micro display and supply electric energy for operation of said micro display.

7. The intelligent virtual display device according to claim 6, wherein said micro display further includes
a substrate;
a receiver, disposed on said substrate, wherein said receiver is connected with said wireless charging device and said controller, and configured to receive said wireless charging signals of said wireless charging device and said control signals generated by said controller;
a rectifier, disposed on said substrate, wherein said rectifier is connected with said receiver, and configured to receive and rectifying said wireless charging signals;
an energy storage element, disposed on said substrate, wherein said energy storage element is connected with said rectifier, and configured to receive said wireless charging signals having been rectified and to convert said wireless charging signals having been rectified into electric energy for storage;
a driver circuit, disposed on said substrate, wherein the driver circuit is connected with said energy storage element and said receiver, and configured to receive said electric energy and said control signals; and
a light-emitting diode array, connected with said driver circuit, wherein said driver circuit supplies said electric energy to said light-emitting diode array and controls said light-emitting diode array to emit light according to said control signals.

8. The intelligent virtual display device according to claim 7, wherein said energy storage element is an energy storage capacitor.

9. The intelligent virtual display device according to claim 7, wherein said light-emitting diode array is a micro light-emitting diode (micro LED) array or a mini light-emitting diode (mini LED) array.

10. The intelligent virtual display device according to claim 7, wherein said controller further includes a signal transmission device, which is connected with said receiver of said micro display and transmits said control signals to said receiver of said micro display.
